(19) United States
(12) Patent Application Publication
(10) Pub. No.: US 2013/0162474 A1
(43) Pub. Date: Jun. 27, 2013

(54) SIGNAL TRANSMITTING/RECEIVING APPARATUS AND METHOD FOR CONTROLLING POLARIZATION

(71) Applicant: Electronics and Telecommunications Research, Daejeon (KR)

(72) Inventors: Soon-Young EOM, Daejeon (KR); Kwang-Jae LEE, Incheon (KR); Jae-Ick CHOI, Daejeon (KR)

(73) Assignee: Electronics and Telecommunications Research Institute, Daejeon (KR)

(21) Appl. No.: 13/660,473

(22) Filed: Oct. 25, 2012

(30) Foreign Application Priority Data
Dec. 21, 2011 (KR) 10-2011-0139230

(51) Int. Cl. H01Q 21/24

(52) U.S. Cl. 342/361

(57) ABSTRACT

Disclosed are signal transmitting apparatus and method capable of generating polarizations that can be controlled in real time by allocating weights to signals. A signal transmitting method for generating variable polarizations having any vector through a plurality of radiating elements vertical to each other includes: receiving an input signal and separating the input signal into a plurality of separated signals according to the number of radiating elements; and allocating weights for controlling vectors of the variable polarizations to each of the plurality of separated signals, wherein the vectors of the variable polarizations are represented by a vector sum of the plurality of separated signals allocated with weights.

### CROSS-REFERENCE TO RELATED APPLICATIONS

The present application claims priority of Korean Patent Application No. 10-2011-0139230, filed on Dec. 21, 2011, which is incorporated herein by reference in its entirety.

### BACKGROUND OF THE INVENTION

1. Field of the Invention

Exemplary embodiments of the present invention relate to signal transmitting/receiving apparatus and method for controlling polarizations, and more particularly, to a signal transmitting/receiving method and apparatus for transmitting/receiving variable polarizations having any vector using a plurality of radiating elements.

2. Description of Related Art

Types and usage of wireless communication services have been continuously increased and frequency resources that are the most important resources in wireless communications has been depleted accordingly. A MIMO communication technology that is the one of communication methods to overcome a lack of frequency resources is to increase traffic through independent multi-channel transmission using a multiple antenna.

However, an antenna of a communication terminal or a repeater/base station of most of the MIMO communications uses an antenna system having fixed variable polarizations and therefore, is difficult to cope with the degradation in communication quality occurring at the time of inter-service interference due to the expansion and broadband of service. In addition, the antenna system in accordance with the related art has a limitation in overcoming the lack of the frequency resources.

### SUMMARY OF THE INVENTION

An embodiment of the present invention is directed to signal transmitting/receiving apparatus and method capable of improving a quality of wireless communication services and increasing traffic by variably controlling fixed polarizations of a wireless communication antenna in accordance with the related art in real time.

Another embodiment of the present invention is directed to signal transmitting/receiving apparatus and method capable of being adapted to various services and complex wireless environment and effectively operating wireless propagation.

The foregoing and other objects, features, aspects and advantages of the present invention will be understood and become more apparent from the following detailed description of the present invention. Also, it can be easily understood that the objects and advantages of the present invention can be realized by the units and combinations thereof recited in the claims.

A signal transmitting method for controlling polarizations includes: separating an input signal into a plurality of separated signals and allocating weights for controlling vectors of variable polarizations to each of the separated signals; generating a wirelessly transmittable type of transmitting signals using the separated signals allocated with the weights; and transmitting each transmitting signal corresponding to a plurality of radiating elements through the radiating elements vertical to each other to generate the variable polarizations.

A signal receiving method for controlling polarizations includes: receiving variable polarizations having any vector through a plurality of radiating elements vertical to each other; separating received signals having different characteristics from orthogonal components of the received variable polarizations and allocating weights to each of the separated received signals; and combining signals having the same characteristics among received signals allocated with the weights.

A signal receiving apparatus for controlling polarizations includes: a weight control unit configured to separate an input signal into a plurality of separated signals and allocate weights for controlling vectors of variable polarizations to each of the separated signals; a transmitting signal generating unit configured to generate a wirelessly transmittable type of transmitting signals using the separated signals allocated with the weights; and an antenna unit configured to transmit each transmitting signal corresponding to a plurality of radiating elements through the radiating elements vertical to each other to generate the variable polarizations.

A signal receiving apparatus for controlling polarizations includes: an antenna unit configured to receive variable polarizations having any vector through a plurality of radiating elements vertical to each other; a signal separator configured to separate received signals having different characteristics from orthogonal components of the received variable polarizations; a weight allocator configured to allocate weights to each of the separated received signals; and a signal combiner configured to combine signals having the same characteristics among received signals allocated with the weights.

### BRIEF DESCRIPTION OF THE DRAWINGS

FIG. 1 is a diagram illustrating a plurality of radiating elements vertical to each other in accordance with an embodiment of the present invention.

FIG. 2 is a diagram for describing a principle of controlling variable polarizations in accordance with an embodiment of the present invention.

FIG. 3 is a block diagram illustrating a configuration of a signal transmitting apparatus in accordance with an embodiment of the present invention.

FIG. 4 is a block diagram illustrating the configuration of the signal transmitting apparatus in accordance with the embodiment of the present invention when a weight control unit processes a signal in a baseband.

FIG. 5 is a block diagram illustrating the configuration of the signal transmitting apparatus in accordance with the embodiment of the present invention when the weight control unit is located at a digital stage.

FIG. 6 is a configuration diagram for describing an operating principle of the weight control unit in accordance with the embodiment of the present invention.

FIG. 7 is a diagram illustrating a multiple antenna in accordance with the embodiment of the present invention.

FIGS. 8 and 9 are diagrams illustrating an embodiment in which the signal transmitting apparatus in accordance with the embodiment of the present invention is applied to a terminal.

FIGS. 10 and 11 are diagrams illustrating an embodiment of a MIMO and a multi-band antenna to which the signal transmitting apparatus in accordance with the present invention is applied.

FIG. 12 is a block diagram illustrating a configuration of a signal receiving apparatus in accordance with another embodiment of the present invention.

FIG. 13 is a flow chart for describing a signal transmitting method in accordance with another embodiment of the present invention.

FIG. 14 is a flow chart for describing the signal transmitting method in accordance with the embodiment of the present invention when an input signals is a baseband signal.

FIG. 15 is a flow chart for describing the signal transmitting method in accordance with the embodiment of the present invention when an input signal is a digital modulation signal.

FIG. 16 is a flow chart for describing a signal receiving method in accordance with another embodiment of the present invention.

### DESCRIPTION OF SPECIFIC EMBODIMENTS

The above-mentioned objects, features, and advantages will be described in detail with reference to the accompanying drawings. Therefore, exemplary embodiments will be described in detail with reference to the accompanying drawings so that they can be easily practiced by those skilled in the art to which the present invention pertains. Further, when it is determined that the detailed description of the known art related to the present invention may obscure the gist of the present invention, the detailed description thereof will be omitted. Hereinafter, exemplary embodiments of the present invention will be described in detail with reference to the accompanying drawings. In the drawings, like reference numerals denote same or like components.

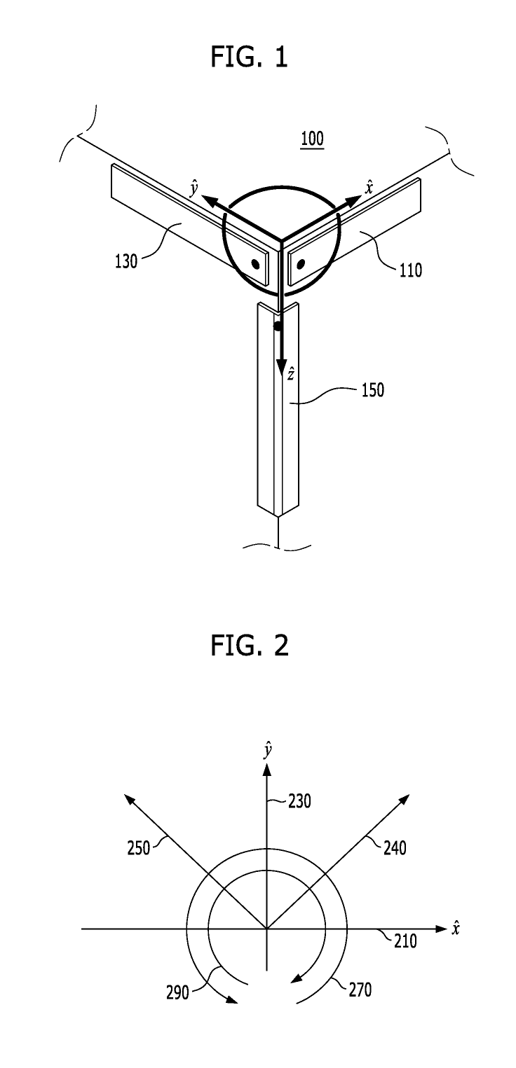

Hereinafter, a principle of controlling variable polarizations in accordance with an embodiment of the present invention will be described with reference to FIGS. 1 and 2.

FIG. 1 is a diagram illustrating a plurality of radiating elements vertical to each other in accordance with an embodiment of the present invention.

The plurality of radiating elements vertical to each other used for the present invention are applied to signal transmitting apparatus and method in accordance with an embodiment of the present invention may generate variable polarizations having any vector.

As illustrated in FIG. 1, the radiating elements may be located at three axes vertical to one another. In this case, the radiating element may have a whip structure, a retractable structure, or a foldable structure, but is not limited thereto. In addition, the radiating element may be applied to any antenna such as a monopole antenna, a dipole antenna, and the like, and therefore, a type of antennas is not limited.

FIG. 2 is a diagram for describing a principle of controlling variable polarizations in accordance with an embodiment of the present invention.

Referring to FIGS. 1 and 2, each radiating element 110, 130, and 150 may generate polarizations of x, y, and z-axis components. In this case, a new polarization is generated due to a vector sum of two-axis polarizations. For example, when a polarization 210 generated from an x-axis radiating element 110 and a polarization 230 generated from a y-axis radiating element have the same weight, a new polarization is generated by the sum of vectors of two polarizations.

$${\overline{E}}_{240} = \frac{1}{\sqrt{2}} \vert {\overline{E}}_{210} \vert ∠θ + \frac{1}{\sqrt{2}} \vert {\overline{E}}_{230} \vert ∠θ \\ {\overline{E}}_{250} = \frac{1}{\sqrt{2}} \vert {\overline{E}}_{210} \vert ∠ ( θ + 180 ° ) + \frac{1}{\sqrt{2}} \vert {\overline{E}}_{230} \vert ∠θ \\ {\overline{E}}_{270} = \frac{1}{\sqrt{2}} \vert {\overline{E}}_{210} \vert ∠θ + \frac{1}{\sqrt{2}} \vert {\overline{E}}_{230} \vert ∠ ( θ - 90 ° ) \\ {\overline{E}}_{290} = \frac{1}{\sqrt{2}} \vert {\overline{E}}_{210} \vert ∠ ( θ - 90 ° ) + \frac{1}{\sqrt{2}} \vert {\overline{E}}_{230} \vert ∠θ \qquad [ Equation 1 ]$$

In the above Equation 1, the weight in the x-axis radiating element 110 may be represented by |Ē₂₁₀|∠θ and the weight in the y-axis radiating element 110 may be represented by |Ē₂₁₀|∠θ (corrected to 230), Referring to the above Equation 1, it can be appreciated that various polarizations may be generated by controlling weights allocated to each polarization.

The above Equation 1 describes only the new polarization generated by the polarizations radiated from the x-axis and y-axis radiating elements, but when the above Equation 1 is applied to x, y, and z axes, more various variable polarizations may be generated.

That is, all the linear polarizations that may be generated on an x-y plan using the x-axis and y-axis polarization components may be generated and the left and right polarizations rotating on the x-y plane may be generated. As another embodiment, all the linear polarizations that may be generated on an x-y plan may be generated using the x-axis and y-axis polarization components and the left and right polarizations rotating on the x-y plane may be generated. As another embodiment, all the linear polarizations that may be generated on an z-x plan using the z-axis and x-axis polarization components may be generated and the left and right polarizations rotating on the z-x plane may be generated. The above contents are an embodiment of the present invention. Meanwhile the user desired polarizations may be generated by controlling weights allocated to each polarization regardless of phase and amplitude and therefore, the present invention is not limited to the above embodiments.

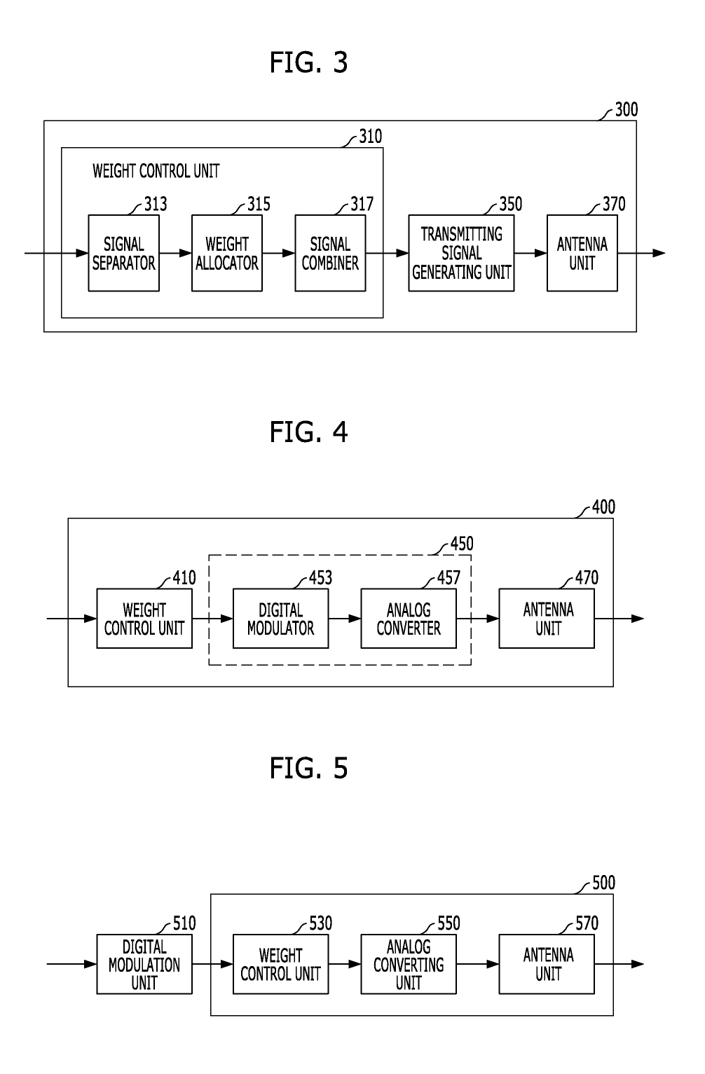

FIG. 3 is a block diagram illustrating a configuration of a signal transmitting apparatus in accordance with an embodiment of the present invention.

A signal transmitting apparatus 300 in accordance with the embodiment of the present invention may include a weight control unit 310, a transmitting signal generating unit 350, and an antenna unit 370, wherein the weight control unit 310 may include a signal separator 313, a weight allocator 315, and a signal combiner 317.

The weight control unit 310 separates an input signal into a plurality of separated signals and allocates weights for controlling vectors of variable polarizations to each separated signal.

In more detail, the weight control unit 310 may receive a single signal and a plurality of signals, wherein the signal separator 313 of the weight control unit 310 separates the input signal into a plurality of separated signals according to the number of radiating elements. For example, when the input signal is one and the number of radiating element is three, the signal separating unit 313 separates the input signal into three separated signals. In this case, each separated signal is the same as the input signal before the weights are allocated thereto. When two different input signals are input and the number of radiating elements is three, each input signal is separated into three that is the number of radiating elements and therefore, the separated signal may be a total of six.

The weight allocator 315 allocates the weights for controlling the vectors of the variable polarizations to each of the plurality of separated signals. That is, the weight allocator 315 may allocate the weights capable of independently controlling the amplitudes and phases of the signals separated by the signal separator 313 to the separated signals. In this case, the weight may be represented by the amplitude and phase. For example, when two different input signals each are separated into three by the signal separator 313, the number of signals to which the weights are allocated is six. Each signal is independent and the weights are to control the vectors of the radiated variable polarizations and therefore, the weights allocated to six signals may be changed according to the vector values of the desired polarizations. As described with reference to FIG. 2, the weights allocated to each signal are considered in consideration of the vector sum of the polarizations radiated from each radiating element.

The signal combiner 318 combines the signals radiated from the same radiating elements among the separated signals to which the weights are allocated, when the input signal is plural.

When the input signal is one, the signals separated as many as the number of radiating elements by the signal separator 313 are independently allocated with weights from the weight allocator 315 according to the output radiating signals. The signals allocated with the weights are then converted into a wirelessly transmittable type of RF signals and thus, radiated through a plurality of different radiating elements.

However, in the case in which the input signals are plural, when each signal is separated as many as the number of radiating elements by the signal separator 313, a process of combining the signals again according to the radiating elements corresponding to each signal needs to performed. For example, when intending to radiate data 1 and data 2 through the radiating elements located on the x, y, and z axes, each signal is allocated with the independent weights according to whether each signal is radiated through the x-axis radiating element or the y-axis radiating element. For generating the variable polarization for the data 1, the separated signals to which the independent weights are allocated are subjected to a conversion process to the following RF signal to be radiated through the radiating elements located on the x, y, and z axes, which is likewise applied to the data 2. Therefore, the signal combiner 317 combines the data 1 and the data 2 separated so as to be allocated the weights to simultaneously transmit two signals through the radiating elements of each axis.

The vectors of the variable polarizations are represented by the vector sum of the plurality of separated signals allocated with the weights and the detailed description thereof is the same as one described with reference to FIG. 2.

The weight control unit 310 according to the embodiment of the present invention can process signals even in any portion. That is, the weight control unit 310 may receive and process the baseband signal that is a pure input data, process modulated digital signals, and process an analog signals such as IF and RF signals. That is, in all the signal processing processes for data transmission, the signals may also be processed to generate the variable polarizations having the desired vectors.

The transmitting signal generating unit 350 generates a wirelessly transmittable type of transmitting signals using the separated signals allocated with the weights. As described above, the weight control unit 310 according to the embodiment of the present invention can perform the signal processing of allocating the weights to the signals in all the bands and then, the processing of the transmitting signal generating unit 350 may be changed according to the output signals of the weight control unit 310. For example, when the signal input to the weight control unit 310 is the IF signal, the transmitting signal generating unit 350 may frequency-convert the signal output from the weight control unit 310 into the RF band. When the signal input to the weight control unit 310 is the RF signal, the transmitting signal generating unit 350 does not need to perform the separate processing and therefore, the transmitting signal generating unit 350 may serve to transmit the RF signal allocated with the weights to the antenna unit 370. Further, the detailed embodiment of the case in which the weight control unit 310 is located at the baseband or the digital stage to perform the signal processing will be described with reference to FIGS. 4 and 5.

The antenna unit 370 transmits each transmitting signal corresponding to the radiating elements through the plurality of radiating elements vertical to each other to generate the variable polarizations. That is, the antenna unit 370 transmits each transmitting signal as orthogonal components of the variable polarizations through the plurality of radiating elements and as described above, the vector values of the variable polarizations may be represented by the vector sum of each transmitting signal allocated with the weights.

FIG. 4 is a block diagram illustrating the configuration of the signal transmitting apparatus according to the embodiment of the present invention when the weight control unit processes the signal in a baseband.

A signal transmitting apparatus 400 according to the embodiment of the present invention may include a weight control unit 410, a transmitting signal generating unit 450, and an antenna unit 470, wherein the transmitting signal generating unit 450 may include a digital modulator 453 and an analog converter 457.

When the signal input to the weight control unit 410 is a baseband signal, the weight control unit 410 separates the input baseband signal into the plurality of separated signals according to the number of radiating elements and allocates weights for controlling the vectors of the variable polarizations to each of the plurality of separated signals.

When the baseband signal input to the weight control unit 410 is plural, the weight control unit 410 combines the plurality of signals radiated through the same radiating elements among the separated signals allocated with the weights.

The baseband signal allocated with the independent weights according to the radiating element to be radiated is input to the digital modulator 453. The digital modulator 453 digitally modulates the baseband signals allocated with the weights and may use any modulation type.

The analog converter 457 generates the RF signal using the digital modulation signal. In more detail, the analog converter 457 converts the digital modulation signal into a signal in an intermediate frequency band, which is then converted into the analog IF signal by digital-to-analog conversion. Further, the wirelessly transmittable type of transmitting signals in the RF band may be generated by the RF frequency conversion.

The antenna unit 470 transmits each transmitting signal corresponding to the radiating elements through the plurality of radiating elements vertical to each other to generate the variable polarizations.

FIG. 5 is a block diagram illustrating the configuration of the signal transmitting apparatus according to the embodiment of the present invention when the weight control unit is located at the digital stage.

A signal transmitting apparatus 500 according to the embodiment of the present invention may include a weight control unit 530, a transmitting signal generating unit 550, and an antenna unit 570 when the input signal is the digital modulation signal, wherein the transmitting signal generating unit 550 may include an analog conversion unit 550.

When the input signal input to the weight control unit 530 is the digital modulation signal output from a digital modulation unit 510, the weight control unit 530 separates the input digital modulation signal into the plurality of separated signals according to the number of radiating elements and allocates the weights for controlling the vectors of the polarizations to each of the plurality of separated signals. In this case, when the baseband signal input to the weight control unit 530 is plural, the weight control unit 530 combines and outputs the plurality of signals radiated through the same radiating elements among the separated signals allocated with the weights.

The analog conversion unit 550 generates the RF signal using the digital modulation signal allocated with the weights. In more detail, the analog conversion unit 550 converts the digital modulation signal allocated with the weights into a signal in an intermediate frequency band, which may be then converted into the analog IF signal by the digital-to-analog conversion. Further, the transmitting signal in the RF band may be generated by the RF frequency conversion.

The antenna unit 570 radiates the transmitting signal generated from the analog conversion unit 550 through the plurality of radiating elements. In this case, each radiating element vertical to each other radiates each transmitting signal as the orthogonal components of the variable polarizations and therefore, the variable polarizations having the vector sum of the polarizations radiated through each radiating element are generated. The variable polarizations generated from the antenna unit 570 are generated by the weights allocated by the weight control unit 530 and therefore, when the weights are controlled by the weight control unit 530, the polarizations having other vector values or other types may be generated.

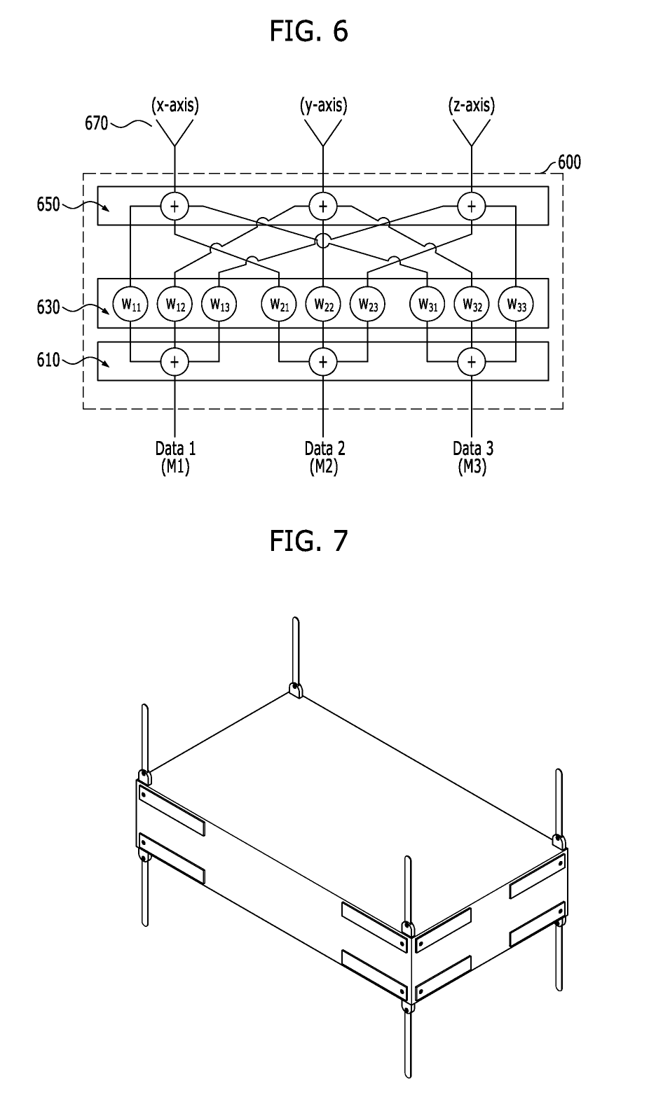

FIG. 6 is a configuration diagram for describing an operating principle of the weight control unit according to the embodiment of the present invention. In more detail, FIG. 6 illustrates the embodiment of the case in which the weight control unit receives three RF signals independent from each other and transmits the received three RF signals to the antenna unit including the radiating elements located on three axes vertical to each other. This configuration may be used in the signal receiving apparatus as it is.

Referring to FIG. 6, a weight control unit 600 according to the embodiment of the present invention includes a signal separator 610 separating the input signal, a weight allocator 630, a signal combiner 650 and the transmitting signal output from the weight control unit 600 may be transmitted through the radiating elements included in the antenna unit 670. The following description is reversely applied the case in which the weight control unit 600 is used for the signal receiving apparatus. Meanwhile, it is to be noted that the signal combiner 650 in a receiving mode is operated like the signal separator and the signal separator 610 is operated like the signal combiner.

First, when signals M1, M2, and M3 carrying Data 1, Data 2, and Data 3 are input to the weight control unit 600 according to the embodiment of the present invention, the signal separator 610 separates M1, M2, and M3, respectively, into three that is the number of radiating elements.

The weight allocator 630 allocates the weights to the signals separated by the signal separator 610. The signals separated by the signal separator 610 is a total of nine and therefore, weight factors W_{11, W}₁₂, W₁₃, W₂₁, W₂₂, W₂₃, W₃₁, W₃₂, and W₃₃ capable of controlling the vectors of the separated signals, that is, amplitudes and phases are independently allocated to nine signals. The weights may generate three independent orthogonal polarizations from the antenna unit.

The following Table 1 shows weight factor values that may generate two independent variable orthogonal polarizations on the x-y plane and a single independent orthogonal polarization on a z-axis. The weights are represented by the amplitude and the phase, where α is an angle of the variable polarization to the x-y plane when z=0 and represents an eigen feature of the variable polarizations generated by the vector sum of the polarizations radiated from each radiating element.

TABLE 1

| | | Phase | |
|---|---|---|---|
| Weight | | (Reference | Spherical |
| Variables | Amplitude | Value = 0°) | Polarization |
| W₁₁ | cos α | 0° | +α linear |
| W₁₂ | Sin α | 0° | polarization |
| W₁₃ | 0.0 | | (on x-y plane) |
| W₂₁ | cos α | 180° | (90° − α) |
| W₂₂ | sin α | 0° | linear |
| W₂₃ | 0.0 | | polarization |
| | | | (on x-y plane) |
| W₃₁ | 0.0 | | z-axis linear |
| W₃₂ | 0.0 | | polarization |
| W₃₃ | 1.0 | 0° | |

As another embodiment of the present invention, the following Table 2 shows weight factor values that may generate two independent variable orthogonal polarizations on a y-z plane and a single independent orthogonal polarization on an x-axis. Here, β is an angle of the variable polarizations to the y-z plane when x=0 and represents an eigen feature of the variable polarizations generated by the vector sum of the polarizations radiated from each radiating element.

TABLE 2

| | | Phase | |
|---|---|---|---|
| Weight | | (Reference | Spherical |
| Variables | Amplitude | Value = 0°) | Polarization |
| W₁₁ | 1.0 | 0° | x-axis linear |
| W₁₂ | 0.0 | | polarization |
| W₁₃ | 0.0 | | |
| W₂₁ | 0.0 | | +β linear |
| W₂₂ | cos β | 0° | polarization |
| W₂₃ | sin β | 0° | (on x-y plane) |
| W₃₁ | 0.0 | | (90° − β) |
| W₃₂ | cos β | 180° | linear |
| W₃₃ | sin β | 0° | polarization |
| | | | (on y-z plane) |

As another embodiment of the present invention, the following Table 3 shows weight factor values that may generate two independent variable orthogonal polarizations on a x-z plane and a single independent orthogonal polarization on a y-axis. Here, γ is an angle of the variable polarizations to the x-z plane when y=0 and represents an eigen feature of the variable polarizations generated by the vector sum of the polarizations radiated from each radiating element.

TABLE 3

| | | Phase | |
|---|---|---|---|
| Weight | | (Reference | Spherical |
| Variables | Amplitude | Value = 0°) | Polarization |
| W₁₁ | cos γ | 0° | +γ linear |
| W₁₂ | 0.0 | | polarization |
| W₁₃ | sin γ | 0° | (on x-y plane) |
| W₂₁ | 0.0 | | y-axis linear |
| W₂₂ | 1.0 | 0° | polarization |
| W₂₃ | 0.0 | | |
| W₃₁ | cos γ | 180° | (90° − γ) |
| W₃₂ | 0.0 | | linear |
| W₃₃ | cos γ | 0° | polarization |
| | | | (on x-z plane) |

FIG. 7 is a diagram illustrating a multiple antenna according to the embodiment of the present invention.

The signal transmitting/receiving apparatus according to the embodiment of the present invention may also be used even in the multiple antenna as illustrated in FIG. 7.

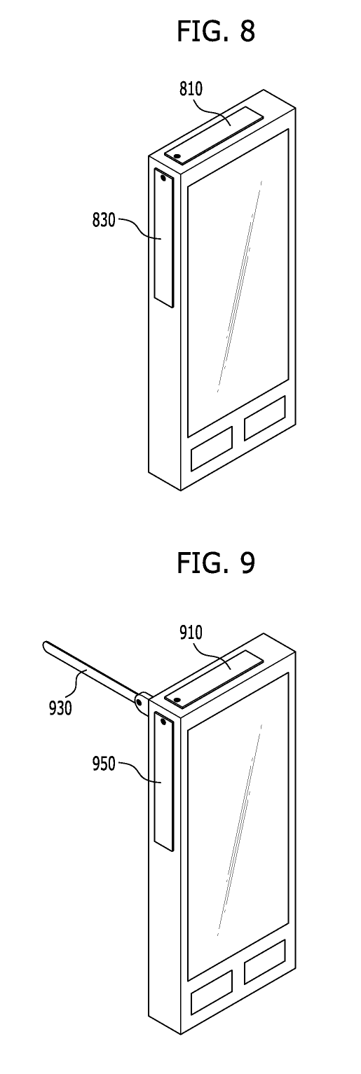

FIGS. 8 and 9 are diagrams illustrating an embodiment in which the signal transmitting/receiving apparatus in accordance with the embodiment of the present invention is applied to the terminal.

As illustrated in FIG. 8, two radiating elements 810 and 830 can be used by being attached to the terminal so as to be located at two axes vertical to each other and as illustrated in FIG. 9, three radiating elements 910, 930, and 950 can be used by being attached to the terminal so as to be located at three axes vertical to one another.

The embodiment in which the antenna is attached as illustrated in FIGS. 8 and 9 may be present in the related art, but the polarizations generated from the radiating elements are fixed. However, when the signal transmitting/receiving apparatus in accordance with the embodiment of the present invention is used, the polarizations can be variously controlled according to the propagation environment, thereby providing the services with the more improved quality than the related art.

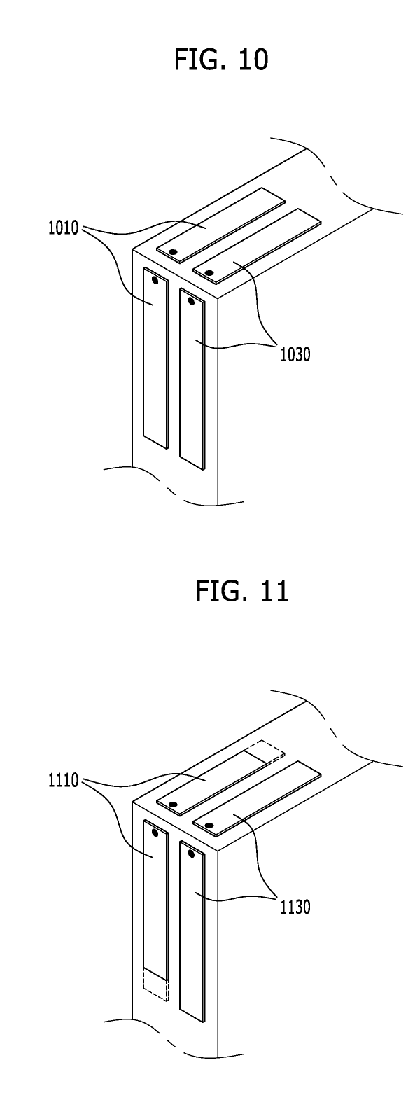

FIGS. 10 and 11 are diagrams illustrating an embodiment of a MIMO and a multi-band antenna to which the signal transmitting/receiving apparatus in accordance with the present invention is applied.

As illustrated in FIGS. 10 and 11, the basic radiating elements can be appropriately modified. As illustrated in FIG. 10, the radiating elements located at the same axis can be used for a MIMO type of system by being separated into plurality such as 1010 and 1030 and as illustrated in FIG. 11, the radiating elements 110 and 1130 separated into plurality may also be applied to a multi-band system by making a physical length or an electrical length thereof different.

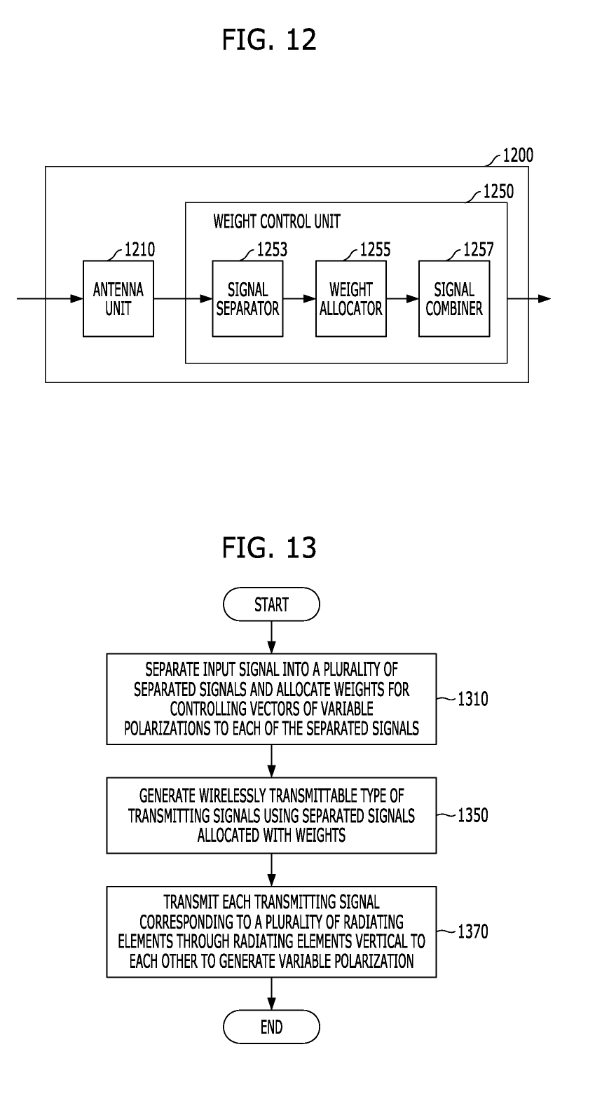

Hereinafter, the signal receiving apparatus in accordance with the embodiment of the present invention will be described with reference to FIG. 12.

FIG. 12 is a block diagram illustrating a configuration of a signal receiving apparatus in accordance with an embodiment of the present invention.

A signal receiving apparatus 1200 in accordance with the embodiment of the present invention may include an antenna unit 1210 and a weight control unit 1250, wherein the weight control unit 1250 may include a signal separator 1253, a weight allocator 1255, and a signal combiner 1257.

First, the antenna unit 1210 receives variable polarizations having any vector through a plurality of radiating elements vertical to each other.

When the antenna unit 1210 receives the variable polarizations including a plurality of signals having different characteristics, the signal separator 1253 of the weight control unit 1250 separates the received signals having different characteristics from the orthogonal components of the received variable polarizations. The weight allocator 1255 allocates weights to the separated received signals and the signal combiner 1257 combines the signals having the same characteristics among the received signals allocated with the weights.

When the antenna unit 1210 receives the variable polarizations carrying a single data, the weight control unit 1250 may allocate the weights to the orthogonal components of the variable polarizations received through each radiating element and may combine the signals allocated with the weights to recover an original signal.

As can be appreciated even in the signal receiving apparatus illustrated in FIG. 12, each component of the signal receiving apparatus in accordance with the embodiment of the present invention can be applied reversely to each component of the foregoing signal transmitting/receiving apparatus.

That is, as a signal receiving apparatus in accordance with another embodiment of the present invention, the variable polarizations received to the antenna unit may be recovered to the original signal through an analog conversion unit, a digital demodulation unit, and a weight control unit. Further, as a signal receiving apparatus in accordance with another embodiment of the present invention, the variable polarizations received to the antenna unit may be recovered to the original signal through an analog converter, a weight control unit, and a digital demodulation unit.

The signal receiving apparatus in accordance with the embodiment of the present invention is not limited to the above embodiments and the weight control unit included in the signal receiving apparatus may process the signals during all the signal processing processes for recovering the original signal like the signal transmitting/receiving apparatus.

FIG. 13 is a flow chart for describing a signal transmitting method in accordance with another embodiment of the present invention.

First, the input signal is separated into a plurality of separated signals and the weights for controlling the vectors of the variable polarizations are allocated to each of the separated signals (1310). In this case, the weights may be represented by the amplitude and phase. In addition, although not illustrated, when the input signal is plural, the signals radiated through the same radiating element among the separated signals allocated with the weights are combined. Next, the wirelessly transmittable type of transmitting signals are generated using the separated signals allocated with the weights (1350) and when the input signal is plural, the wirelessly transmittable type of transmitting signals may be generated using the combined signals. Finally, the variable polarizations are generated by transmitting each transmitting signal corresponding to the radiating elements through the plurality of radiating elements vertical to each other (1370).

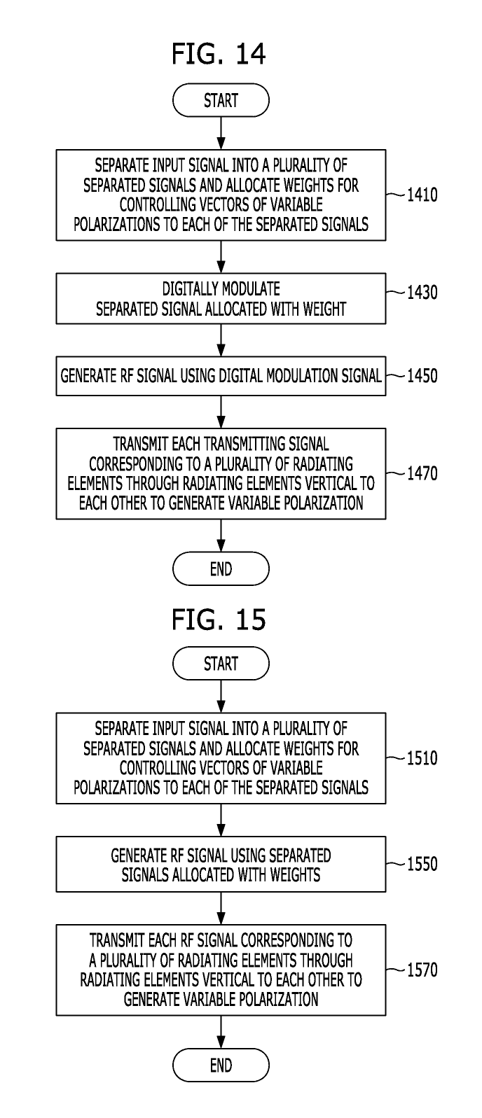

FIG. 14 is a flow chart for describing the signal transmitting method in accordance with the embodiment of the present invention when the input signal is the baseband signal. When the input signal is the baseband signal, the input signal is separated into a plurality of separated signals and the weights for controlling the vectors of the variable polarizations are allocated to each of the separated signals (1410). Next, the separated signals allocated with the weights are digitally modulated (1430). Further, the RF signals are generated using the digital modulation signal (1450). Next, the variable polarizations are generated by transmitting each RF signal corresponding to the radiating elements through the plurality of radiating elements vertical to each other (1470).

FIG. 15 is a flow chart for describing the signal transmitting method in accordance with the embodiment of the present invention when the input signal is the digital modulation signal. When the input signal is the digital modulation signal, the input signal is separated into a plurality of separated signals and the weights for controlling the vectors of the variable polarizations are allocated to each of the separated signals (1510). Further, the RF signal is generated using the separated signal allocated with the weights (1550). Next, the variable polarizations are generated by transmitting each RF signal corresponding to the radiating elements through the plurality of radiating elements vertical to each other (1570).

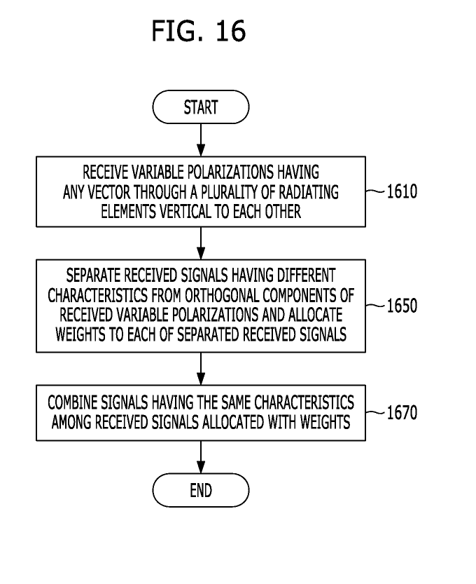

FIG. 16 is a flow chart for describing a signal receiving method in accordance with another embodiment of the present invention.

First, the variable polarizations having any vector are received through the plurality of radiating elements vertical to each other (1610). Next, the received signals having different characteristics are separated from the orthogonal components of the received variable polarizations and the weights are allocated to the separated received signals (1650). Further, the signals having the same characteristics among the received signals allocated with the weights are combined (1670).

As another embodiment of the present invention, when the variable polarizations carrying a single data are received, the weights are allocated to each of the orthogonal components of the variable polarizations received through each radiating element and the signals allocated with the weights are combined, thereby recovering the original signal.

According to the signal transmitting/receiving apparatus and method of the present invention, it is possible to obtain various polarizations, depending on the circumferences. Therefore, in order to resolve the lack of the frequency resources in the communication system, the signal transmitting/receiving apparatus in accordance with the embodiment of the present invention may be used for a base station, a relay station, and a mobile station of the wireless communication system that use the diversity of polarizations.

In addition, in accordance with the embodiment of the present invention, it is possible to remarkably increase the operation data capacity by implementing the generation and control of various polarizations.

Further, in accordance with the embodiment of the present invention, it is possible to improve the quality of services by selecting the best polarization signals in the complex wireless channel environment.

The present invention will be apparent to those skilled in the art that substitutions, modifications and variations can be made without departing from the spirit and scope of the invention and therefore, is not limited to the aforementioned embodiments and the accompanying drawings.

What is claimed is:

1. A signal transmitting method for controlling polarizations, comprising:
separating an input signal into a plurality of separated signals and allocating weights for controlling vectors of variable polarizations to each of the separated signals;
generating a wirelessly transmittable type of transmitting signals using the separated signals allocated with the weights; and
transmitting each transmitting signal corresponding to a plurality of radiating elements through the radiating elements vertical to each other to generate the variable polarizations.

2. The signal transmitting method of claim 1, wherein the weight is represented by amplitude and phase.

3. The signal transmitting method of claim 1, further comprising: when the input signal is plural, combining signals radiated through the same radiating element among the separated signals allocated with the weights,
wherein in the generating of the transmitting signals, the wirelessly transmittable type of transmitting signals are generated using the combined signals.

4. The signal transmitting method of claim 1, wherein when the input signal is a baseband signal, the generating of the transmitting signals includes:
digitally modulating the separated signals allocated with the weights; and
generating an RF signal using the digital modulation signal.

5. The signal transmitting method of claim 1, wherein when the input signal is the digital modulation signal, in the generating of the transmitting signal, the RF signal is generated using the separated signals allocated with the weights.

6. A signal receiving method for controlling polarizations, comprising:
receiving variable polarizations having any vector through a plurality of radiating elements vertical to each other;
separating received signals having different characteristics from orthogonal components of the received variable polarizations and allocating weights to each of the separated received signals; and
combining signals having the same characteristics among the received signals allocated with the weights.

7. A signal transmitting apparatus for controlling polarizations, comprising:
a weight control unit configured to separate an input signal into a plurality of separated signals and allocate weights for controlling vectors of variable polarizations to each of the separated signals;
a transmitting signal generating unit configured to generate a wirelessly transmittable type of transmitting signals using the separated signals allocated with the weights; and
an antenna unit configured to transmit each transmitting signal corresponding to a plurality of radiating elements through the radiating elements vertical to each other to generate the variable polarizations.

8. The signal transmitting apparatus of claim 7, wherein the weight is represented by amplitude and phase.

9. The signal transmitting apparatus of claim 7, wherein when the input signal is plural, the weight control unit further includes a signal combiner combining signals radiated through the same radiating element among the separated signals allocated with the weights, and
the transmitting signal generating unit generates the wirelessly transmittable type of transmitting signals using the combined signals.

10. The signal transmitting apparatus of claim 7, wherein when the input signal is a baseband signal, the transmitting signal generating unit includes:
a digital modulator configured to digitally modulating the separated signals allocated with the weights; and
an analog converter configured to generate an RF signal using the digital modulated signal.

11. The signal transmitting apparatus of claim 7, wherein when the input signal is the digital modulation signal, the signal transmitting unit generates the RF signal using the separated signals allocated with the weights.

12. A signal receiving apparatus for controlling polarizations, comprising:
an antenna unit configured to receive variable polarizations having any vector through a plurality of radiating elements vertical to each other;
a signal separator configured to separate received signals having different characteristics from orthogonal components of the received variable polarizations;
a weight allocator configured to allocate weights to each of the separated received signals; and
a signal combiner configured to combine signals having the same characteristics among the received signals allocated with the weights.
